(19) United States
(12) Patent Application Publication
(10) Pub. No.: US 2008/0039576 A1
(43) Pub. Date: Feb. 14, 2008

(54) Vulcanizate composition

(75) Inventors: Roy M. Griswold, Ballston Spa, NY (US); Francis J. McKeon, Queensbury, NY (US); Timothy J. Fahrenkopf, East Greenbush, NY (US); Philbert E. Ramdatt, New York, NY (US)

Correspondence Address: DILWORTH & BARRESE, LLP, 333 EARLE OVINGTON BLVD., SUITE 702, UNIONDALE, NY, 11553, US

(73) Assignee: General Electric Company, Schenectady, NY (US)

(21) Appl. No.: 11/504,563

(22) Filed: Aug. 14, 2006

(51) Int. Cl. C09B 67/00

(52) U.S. Cl. 524/502; 525/192

(57) ABSTRACT

In one embodiment herein there is provided a hot melt vulcanizate composition made by the process comprising:
a) producing a reaction product (i) from (1) at least one first resin selected from the group consisting of thermoplastic polymer and elastomeric polymer, (2) at least one unsaturated carboxylic acid anhydride, (3) at least one alkylamine possessing two or more amine functionalities, and optionally (4) at least one free-radical generating catalyst, and wherein said reaction product (i) optionally further comprises, at least one first additive; and, optionally,
b) blending said reaction product (i) with at least one second resin selected from the group consisting of thermoplastic polymer and elastomeric polymer, provided that at least one of second resin is different from at least one of first resin and, optionally, at least one second additive;
c) curing said reaction product (i), wherein reaction product (i) has been blended as in (b) above, or not, to produce a hot melt vulcanizate composition; and, optionally,
d) adding at least one third additive to the hot melt vulcanizate composition.

### BACKGROUND OF THE INVENTION

(1) Field of the Invention

The present disclosure provides for a hot melt vulcanizate composition.

(2) Description of Related Art

There are sealant/adhesive compositions, which utilize silane crosslinked hot melts to improve adhesion, tensile strength and thermal resistance as desirable properties. Unfortunately silane crosslinked hotmelts require the addition of further additives and/or processing steps to provide desirable physical properties to a sealant/adhesive composition. Additional sealant/adhesive desirable properties include adequate green strength and economical cure time for ease of handling, along with maintaining adhesion during thermal cycles. The sealant/adhesives desirable properties further include a tensile strength of 200 pounds per square inch (psi) or greater, 100% modulus of 100 psi or greater, elongation of 200% or greater, and Shore A Hardness of 30 or greater. A sealant/adhesive that can be used as a single seal offers lower cost due to use of automated application.

Two general types of adhesives and sealants exist. These include thermoset and thermoplastic compositions. Chemically cured thermoset compositions include polysulfides, polyurethanes, and silicones. Thermoplastic compositions include hot melt butyl rubber based compositions. The desirability for hot melt butyl compositions is due to their low moisture vapor transmittance (MVT) property. However, these compositions are susceptible to poor adhesion and creep resistance due to low and high temperature fluctuations, leading to deformation of constructions assembled using said compositions.

There is yet a need for a hot melt composition having an extended range of physical and thermal properties as well as improved creep resistance.

### BRIEF SUMMARY OF THE INVENTION

The inventors have unexpectedly discovered a hot melt vulcanizate composition that contains advantageous physical and/or thermal properties.

In one specific embodiment there is provided herein a hot melt vulcanizate composition made by the process comprising:

a) producing a reaction product (i) from (1) at least one first resin selected from the group consisting of thermoplastic polymer and elastomeric polymer, (2) at least one unsaturated carboxylic acid anhydride, (3) at least one alkylamine possessing two or more amine functionalities, and optionally (4) at least one free-radical generating catalyst, and wherein said reaction product (i) optionally further comprises, at least one first additive; and, optionally,

b) blending said reaction product (i) with at least one second resin selected from the group consisting of thermoplastic polymer and elastomeric polymer, provided that at least one of second resin is different from at least one of first resin and, optionally, at least one second additive;

c) curing said reaction product (i), wherein reaction product (i) has been blended as in (b) above, or not, to produce a hot melt vulcanizate composition; and, optionally,

d) adding at least one third additive to the hot melt vulcanizate composition.

### DETAILED DESCRIPTION OF THE INVENTION

The present disclosure describes a hot melt vulcanizate composition, such as the non-limiting example of a thermoplastic and/or elastomeric vulcanizate made by a process that advantageously incorporates an alkylamine possessing at two or more amine functionalities to effectively cross-link a reaction product of components including said alkylamine, which increases creep resistance and improves other physical properties of said hot melt vulcanizate composition without the use of a silane cross-linker. The present disclosure also describes an adhesive comprising said hot melt vulcanizate composition. It will be understood that the U.S. patent application entitled Composite Structure, filed on even date herewith, to the same inventors as herein, is incorporated by reference herein in its entirety. It will also be understood herein that the terms adhesive or sealant shall be understood to be the same as the phrase adhesive and/or sealant.

In one embodiment herein, it will be understood that all ranges herein include all sub-ranges there between. In another specific embodiment herein, it will be understood that all listings of members of a group can further comprise combinations of any two or more of the members of said group. In one other embodiment herein, it will be understood that the term “polymer” can comprise polymer and/or copolymer.

In one embodiment herein, reaction product (i) is a dispersed phase and the second resin and, optionally, at least one second additive, is a continuous phase. In another embodiment herein, reaction product (i) can be a continuous phase and second resin and, optionally, at least one second additive can be a dispersed phase. In yet another embodiment, reaction product (i) can comprise both the dispersed phase and continuous phase such as in the non-limiting example when resin (1) comprises a mixture of thermoplastic polymer and elastomeric polymer, wherein thermoplastic polymer or elastomeric polymer can be the dispersed phase. In a more specific embodiment, dispersed phase can be present in hot melt vulcanizate composition in a smaller amount than continuous phase; wherein continuous phase occupies a majority of hot melt vulcanizate composition and dispersed phase occupies a minority of hot melt vulcanizate composition. In one embodiment herein, dispersed phase can be present in hot melt vulcanizate composition in an amount of specifically from about 5 to about 40 wt %, more specifically of from about 10 to about 35 wt % and most specifically of from about 15 to about 30 wt %. In one embodiment herein, continuous phase can be present in hot melt vulcanizate composition in an amount of specifically from about 95 to about 60 wt %, more specifically of from about 90 to about 65 wt % and most specifically of from about 85 to about 70 wt %.

In another embodiment herein reaction product (i) can comprise a blend of a dispersed phase of the chemically cross-linked product of first resin (1) chemically linked to the carboxylic acid anhydride (2) and alkylamine possessing two or more amine functionalities (3) in a continuous phase of first resin (1). In yet another specific embodiment herein in reaction product (i), at least one first additive can comprise the same or different additive, in addition to any of at least one second additive. In a more specific embodiment, reaction product (i) is a dispersed phase of the chemically cross-linked product of first resin (1) chemically linked to the carboxylic acid anhydride (2), alkylamine possessing two or more amine functionalities (3) and at least one first additive, with the other components (1) and (4), in a continuous phase of second resin. In yet another embodiment first resin (1) is an elastomeric polymer and second resin is a thermoplastic polymer. In yet a further embodiment herein, reaction product (i) can be the result of at least one chemical reaction between any of the components (1)-(4) or intermediate reaction products thereof, which are subsequently combined (blended) with the other components that do not take part in said chemical reaction, if any, and wherein said chemical reaction is selected from the group consisting of grafting, cross-linking and coupling. In a further embodiment herein, it will be understood that reaction product (i) can come from the combination of components (1), (2), (3) and optionally (4), wherein said reaction product (i) is produced by any sequential combination of all of the components or any intermediate reaction product of any combination of said components, in any order and/or combination, or the simultaneous combination of all the components. In another specific embodiment herein, said reaction product (i) shall not comprise an actual reaction of (1) and (3), in the presence or absence of (4) or any other component or intermediate reaction product but can be used as a mixture of (1) and (3) which can be reacted in any fashion as described above. In a further embodiment herein, it will be understood that reaction product (i) can be formed from the use of any mixture of two or more components (1), (2), (3) and optionally (4), even if said mixture does not in of itself comprise a reaction product of said two or more components. In yet another embodiment, reaction product (i) can come from the reaction of any of components (1), (2), (3) and optionally (4) followed by the optional further addition of the same first resin (1), wherein said further addition can comprise any amount of first resin (1) provided that the total amount of first resin (1) totals what is described herein.

In yet a further embodiment herein, thermoplastic polymer of first and second resin can be any thermoplastic polymer and/or copolymer which can be reacted with carboxylic acid anhydride to yield a carboxylic acid anhydride containing thermoplastic polymer and/or copolymer. In one embodiment herein thermoplastic polymer of first and second resin can be any of the non-limiting examples selected from the group consisting of homopolymers and copolymers of polypropylene (PP); polyethylene, especially high density (PE); polystyrene (PS); acrylonitrile butadiene styrene (ABS); styrene acrylonitrile (SAN); polymethylmethacrylate (PMMA); polyester, which is thermoplastic such as the non-limiting examples of polyethylene terephthalate (PET) and polybutylene terephthalate (PBT); polycarbonate (PC); polyamide (PA); polyphenylene ether (PPE); polyphenylene oxide (PPO); and combinations thereof, provided that at least one of second resin is different from at least one of first resin. In one embodiment herein, thermoplastic polymer can be made by any process known in the art, including, but not limited to, by bulk phase, slurry phase, gas phase, solvent phase, interfacial, polymerization (radical, ionic, metal initiated (e.g., metallocene, Ziegler-Natta)), polycondensation, polyaddition or combinations of these methodologies. The melting point of the thermoplastic polymer should be less than the decomposition temperature of the alkylamine possessing two or more amine functionalities (3), as well as the decomposition temperature of the acid anhydride (2) (unless the acid anhydride is a comonomer in the first resin (1)).

In a further embodiment herein, elastomeric is a polyolefin rubber phase component including, but not limited to, any elastomeric polymer and/or copolymer which can be reacted with carboxylic acid anhydride to yield a carboxylic acid anhydride containing elastomeric polymer and/or copolymer. In one specific embodiment herein, elastomeric polymer of the first and second resin can be any of the non-limiting examples selected from the group consisting of ethylene propylene copolymer (EPR); ethylene propylene diene terpolymer (EPDM); butyl rubber (BR); natural rubber (NR); chlorinated polyethylenes (CPE); silicone rubber; isoprene rubber (IR); butadiene rubber (BR); styrene-butadiene rubber (SBR); styrene-ethylene butylene-styrene block copolymer (SEBS); ethylene-vinyl acetate (EVA); ethylene butylacrylate (EBA); ethylene methacrylate (EMA); ethylene ethylacrylate (EEA); ethylene-alpha-olefin copolymers (e.g., EXACT and ENGAGE, LLDPE (linear low density polyethylene)), high density polyethylene (HPE); nitrile rubber (NBR) and combinations thereof, provided that at least one of second resin is different from at least one of first resin. In one specific embodiment, polypropylene homopolymer is not suitable as elastomeric polymer since it has a tendency to degrade during cross-linking; however, if polypropylene is a copolymer or graftomer of polypropylene with an acid anhydride, then it can be used. In a more specific embodiment, elastomeric polymer is an ethylene polymer or copolymer with at least 50% ethylene content (by monomer), more specifically at least 70% of the monomers are ethylene and most specifically at least 80% of the monomers are ethylene. In one embodiment herein, elastomeric polymer must be extrudable and should be capable of grafting with the acid anhydride (2) or be capable of being modified by the acid anhydride (2) during its manufacture. In one embodiment herein, elastomeric polymer can be made by any process known in the art, including, but not limited to, by bulk phase, slurry phase, gas phase, solvent phase, interfacial, polymerization (radical, ionic, metal initiated (e.g., metallocene, Ziegler-Natta)), polycondensation, polyaddition or combinations of these methodologies. The melting point of the elastomeric polymer should be less than the decomposition temperature of the alkylamine possessing two or more amine functionalities (3), as well as the decomposition temperature of the acid anhydride (2) (unless the acid anhydride is a comonomer in the first resin (1)).

In one embodiment herein both thermoplastic polymer and/or elastomeric polymer may have unimodal, bimodal or multimodal molecular weight distributions. The melt flow of these polymers and/or copolymers may be any of those known in the art for use in forming thermoplastics and rubbers.

In yet an even further embodiment herein carboxylic acid anhydride (2) is any unsaturated carboxylic acid anhydride, which can be grafted or reacted onto or into first resin (1) by any possible mechanism. In a more specific embodiment, there is at least one unsaturation either in the first resin (1), and also more specifically, in the acid anhydride (2), which can be used to accomplish the above-described grafting. In a more specific embodiment, unsaturation of the carboxylic acid anhydride (2) can be internal or external to a ring structure, if present, so long as it allows for reaction with said first resin (1). In an even more specific embodiment, acid anhydride (2) can include halides. In another even more specific embodiment herein, mixtures of different unsaturated carboxylic acid anhydrides can be used. In one specific embodiment, some non-limiting examples of unsaturated carboxylic acid anhydride (2), suitable for use in herein, include, but are not limited to, those selected from the group consisting of isobutenylsuccinic, (+/−)-2-octen-1-ylsuccinic, itaconic, 2-dodecen-1-ylsuccinic, cis-1,2,3,6-tetrahydrophthalic, cis-5-norbornene-endo-2,3-dicarboxylic, endo-bicyclo[2.2.2]oct-5-ene-2,3-dicarboxylic, methyl-5-norbornene-2,3-carboxylic, exo-3,6-epoxy-1,2,3,6-tetrahydrophthalic, maleic, citraconic, 2,3 dimethylmaleic, 1-cyclopentene-1,2-dicarboxylic, 3,4,5,6-tetrahydrophthalic; and combinations thereof. In one embodiment, acid anhydride (2) can be present as a comonomer in the first resin (1) or can be grafted onto the first resin (1). In a more specific embodiment, the amount of acid anhydride (2) that can be used herein, is specifically about 0.01 to about 1.0 wt %, more specifically about 0.05 to about 0.9 wt % and most specifically about 0.1 to about 0.8 wt % based on the total amount of first resin (1) present.

In another embodiment herein, the free radical generating catalyst (4), can be such as the non-limiting examples selected from the group consisting of a water soluble peroxide; an oil soluble peroxide; and combinations thereof, wherein free-radical generating catalyst (4), is usually present in about half the percentage by weight of the carboxylic acid anhydride (2), although other percentages can be used when appropriate. In another embodiment herein, a free radical generator catalyst (4) can be required if the carboxylic acid anhydride (2) is being grafted by a free radical mechanism onto the above-described first resin (1), but it is not required if the acid anhydride (2) is either grafted via another mechanism or is a comonomer of first resin (1). In one specific embodiment, some suitable free-radical generating catalysts (4) can be water soluble and/or oil soluble peroxides which are selected from the group consisting of inorganic peroxides such as the non-limiting examples of hydrogen peroxide, ammonium persulfate, and potassium persulfate, various organic peroxy catalysts, such as dialkyl peroxides, such as the non-limiting examples of diisopropyl peroxide, dilauryl peroxide, di-t-butyl peroxide, di(2-t-butylperoxyisopropyl)benzene, 3,3,5-trimethyl 1,1-di(tert-butyl peroxy)cylohexane, 2,5-dimethyl-2,5-di(t-butylperoxy)hexane, 2,5-dimethyl-2,5-di(t-butylperoxy)hexyne-3, dicumyl peroxide, alkyl hydrogen peroxides such as the non-limiting examples of t-butyl hydrogen peroxide, t-amyl hydrogen peroxide, cumyl hydrogen peroxide, diacyl peroxides, such as the non-limiting examples of acetyl peroxide, lauroyl peroxide, benzoyl peroxide, peroxy ester such as the non-limiting example of ethyl peroxybenzoate, the azo compounds such as the non-limiting example of 2-azobis(isobutyronitrile), and combinations thereof. The free radical generating catalyst (4) can be present at specifically from about 0.01/1 to about 1/1, more specifically from about 0.1/1 to about 0.9/1, and most specifically from about 0.5/1 to about 0.9/1, based on the molar quantity of acid anhydride (2).

In another embodiment herein, alkylamine possessing two or more amine functionalities (3) must have a sufficient rate of reaction with the acid anhydride (2). In one embodiment a sufficient rate of reaction is one in which (2) is capable of reacting with (3) such as for example where (2) reacts with (3) at the rates of reaction that are present when (2) and (3) are reacted at the temperatures and/or melt flows present in the processes as described herein. In one specific embodiment herein, alkylamine possessing two or more amine functionalities (3) has the general formula (I):

R¹₂N—R—NR²₂ (I)

wherein R is a linear, branched or cyclic divalent alkylene group containing specifically from 1 to about 20 carbon atoms, more specifically from 2 to about 12 carbon atoms and most specifically from 2 to about 8 carbon atoms, said divalent alkylene group optionally specifically containing at least one interposed amine group, more specifically at least two interposed amine groups; each R¹ and R² is independently hydrogen, or the same or different linear or branched alkyl group of specifically from 1 to about 8 carbon atoms, more specifically from 1 to about 6 carbon atoms and most specifically from 1 to about 3 carbon atoms. In an even more specific embodiment alkylamine possessing two or more amine functionalities (3) is at least one of the non-limiting examples selected from the group consisting of 5-amino-1,3,3-trimethylcyclohexanemethylamine; 1,4-diaminocyclohexane; 1,3-propanediamine; 1,3-pentanediamine; isophoronediamine available from Bayer Material Science as EPDA; diethylenetriamine; triethylenetetramine; trimethylhexamethylenediamine; N,N′-dimethylethylenediamine; N,N′-diethyl-1,3-propanediamine; bis(aminomethyl)cyclohexylamine; bis(p-aminocyclohexyl)methane; 2,2′-dimethylbis(p-aminocyclohexyl)methane; 1,2-diaminocyclohexane; metaxylenediamine; norbornanediamine; diethyltoluenediamine; 1,7-diaminoheptane; polyoxypropylene diamines; polyoxypropylene dialkyldiamines such as the non-limiting examples of polyoxypropylene diethyldiamine and N,N′-diethyl-isophoronediamine; diamines such as those available from Huntsman Corporation, under the tradenames of Jefflink 754, Clearlink 1000, Jeffamine D-230, Jeffamine D-400, Jeffamine D-2000, Jeffamine D-4000, Jeffamine XTJ-511, Jeffamine XTJ-500, Jeffamine XTJ-509, Jeffamine T-403, Jeffamine T-5000; and combinations thereof. In one embodiment herein, alkylamine possessing two or more amine functionalities (3) can be present at specifically of from about 0.025 wt % to about 0.25 wt %, more specifically of from about 0.05 wt % to about 0.2 wt %, and most specifically of from about 0.1 wt % to about 0.2 wt %, based on the weight of first resin. In another embodiment herein, alkylamine possessing two or more amine functionalities (3) can be present at a molar equivalency ratio to the acid anhydride (2) of specifically of about 0.1 to 10, more specifically of about 0.9 to 1.1, and most specifically, of about a 1:1 ratio.

In yet an even further specific embodiment herein, at least one first, second and third additive can be a non-limiting example selected from the group consisting of tackifier, plasticizer, silane adhesion promoter, condensation catalyst, other component and combinations thereof.

In one embodiment herein, suitable commercially available tackifying agents include the non-limiting examples selected from the group consisting of partially hydrogenated cycloaliphatic petroleum hydrocarbon resins available under the EASTOTAC series of trade designations including, the non-limiting examples of, EASTOTAC H-100, H-115, H-130 and H-142 from Eastman Chemical Co. (Kingsport, Tenn.) available in grades E, R, L and W, which have differing levels of hydrogenation from least hydrogenated (E) to most hydrogenated (W), the ESCOREZ series of trade designations including, the non-limiting examples of ESCOREZ 5300 and ESCOREZ 5400 from Exxon Chemical Co. (Houston, Tex.), and the HERCOLITE 2100 trade designation from Hercules (Wilmington, Del.); partially hydrogenated aromatic modified petroleum hydrocarbon resins available under the ESCOREZ 5600 trade designation from Exxon Chemical Co.; aliphatic-aromatic petroleum hydrocarbon resins available under the WINGTACK EXTRA trade designation from Goodyear Chemical Co. (Akron, Ohio); styrenated terpene resins made from d-limonene available under the ZONATAC 105 LITE trade designation from Arizona Chemical Co. (Panama City, Fla.); aromatic hydrogenated hydrocarbon resins available under the REGALREZ 1094 trade designation from Hercules; and alphamethyl styrene resins available under the trade designations KRISTALEX 3070, 3085 and 3100, which have softening points of 70EC, 85EC and 100EC, respectively, from Hercules. In yet another embodiment herein, the incorporation of tackifier resins extends the melt flow temperature, tack and adhesion ranges for the dispersed and continuous phases and therein further improves creep resistance.

In another embodiment herein silane adhesion promoter or blends thereof can be incorporated to improve adhesion to various substrates. In one embodiment herein silane adhesion promoter can be of the general formula:

(YₐZB)_{c}Si(OR)_{b}(X)_{4-(b+c)},

wherein a=0 to 2, b=1 to 3, c=1 to 3, with the proviso that b+c is less than or equal to 4, each Y may independently be selected from hydrogen, an alkyl, alkenyl, hydroxy alkyl, alkaryl, alkylsilyl, alkylamine, C(═O)OR or C(═O)NR, C(═O)R, alkylepoxy, Z is N or S or B, R is an acyl, alkyl, aryl or alkaryl, X is R or a halogen wherein R is a monovalent alkyl, B is a divalent straight chain, branched chain, cyclic hydrocarbon, aryl, alkylaryl or combination thereof bridging group, or B may contain at least one heteroatom bridge. In one embodiment some non-limiting examplary silanes are gamma-amino propyl trimethoxy silane (SILQUEST® A-1110 silane from Witco Corp., Greenwich, Conn. USA); gamma-amino propyl triethoxy silane (SILQUEST® A-1100); gamma-amino propyl methyl diethoxy silane; 4-amino-3,3-dimethyl butyl triethoxy silane, 4-amino-3,3-dimethyl butyl methylediethoxysliane, N-beta-(aminoethyl)-gamma-aminopropyltrimethoxysilane (SILQUEST® A-1120), (aminoethyl)-gamma-aminopropylmethyltrimethoxysilane (SILQUEST® A-1130) and N-beta-(aminoethyl)-gamma-aminopropylmethyldimethoxysilane (SILQUEST® A-2120), 3-(N-allylamino)propyltrimethoxysilane, 4-aminobutyltriethoxysilane, 4-aininobutyltrimethoxysilane, (aminoethylaminomethyl)-phenethyltrimethoxysilane, aminophenyltrimethoxysilane, 3-(1-aminopropoxy)-3,3,dimethlyl-1-propenyltrimethoxysilane, bis[(3-trimethoxysilyl)-propyl]ethylenediamine, N-methylaminopropyltrimethoxysilane, bis-(gamma-triethoxysilylpropyl)amine (SILQUEST® A-1170), and N-phenyl-gamma-aminopropyltrimethoxysilane (SILQUEST® Y-9669). In one other embodiment herein other suitable silanes are as follows: mercaptopropyltrimethoxysilane, 3-Octanoylthio-1-propyltrimethoxysilane, tris-(3-(trimethoxysilyl)propyl)isocyanaurate, beta(3,4-epoxycyclohexyl)ethyltrimethoxysilane, and gamma-glycidoxypropyltrimethoxysilane. In one embodiment if the silane is a latent aminosilane, i.e., a ureidosilane or a carbamatosilane, then the blending temperature must be sufficient so that the respective blocking group comes off from the amine and allows the amine to react with the acid anhydride functionality, and is generally about 150 to 230EC. In one embodiment some non-limiting examples of such latent aminosilanes are tert-butyl-N-(3-trimethoxysilylpropyl)carbamate, ureidopropyltriethoxysilane, and ureidopropyltrimethoxysilane. In one embodiment some other non-limiting examples of carbamato silanes which may be used are disclosed in U.S. Pat. No. 5,220,047, which is incorporated herein by reference. In a more specific embodiment, so as to avoid the additional complexity of deblocking, the aminosilane is not such a latent aminosilane. In one embodiment the silane should be present at 250 to 25,000 ppm based on weight of both polymers. In one embodiment the silane should also be present at a molar equivalency ratio to the acid anhydride of about 0.1 to 10, more preferably 0.9 to 1.1, most preferably, about a 1:1 ratio. In one embodiment the silane may be carried on a carrier such as a porous polymer, silica, titanium dioxide or carbon black so that it is easy to add to the polymer during the mixing process. In another embodiment the silane can also be blended with a compatible processing oil. In one embodiment this is especially useful in formulations that already contain oil and/or will benefit from the use of an oil as a processing aid, plasticizer, lower oil absorption formulation and/or softening agent. Exemplary materials are ACCUREL polyolefin (Akzo Nobel), STAMYPOR polyolefin (DSM) and VALTEC polyolefin (Montell), SPHERILENE polyolefin (Montell), AEROSIL silica (Degussa), MICRO-CEL E (Manville) and ENSACO 350G carbon black (MMM Carbon). In one embodiment White oils, i.e., paraffinic oils, are useful carriers for the silane, but any oil compatible with the silane and the composite formulation can be used.

In one specific embodiment herein, other component can be any of those non-limiting examples selected from the group consisting of stabilizers (UV, light or aging), antioxidants, metal deactivators, processing aids, waxes, fillers (silica, TiO₂, CaCO₃, carbon black, silica, etc.), and colorants which can be added to TPV. In a further embodiment, blowing agents can be added to first resin and optional second resin so that when they are extruded the respective extruded polymer and/or copolymer will form foam. In one specific embodiment, some non-limiting examples of such blowing agents are volatile hydrocarbons, hydrofluorocarbons, and chlorofluorocarbons. In another specific embodiment, some commonly know foaming agents that can be used as blowing agent can be the non-limiting examples of azocarbonamide, sodium bicarbonate and combinations thereof; all of which decompose at elevated temperature to yield gaseous products. In another specific embodiment herein, foams of reaction product (i), optionally including second resin, and the hot melt vulcanizate composition formed therefrom, as described herein, can also be produced by injection of liquid or gaseous foaming agent into a polymer melt of the above-described first resin and optional second resin. In one specific embodiment some non-limiting examples of gaseous foaming agent are selected from the group consisting of butane, carbon dioxide, nitrogen, water, helium, and combinations thereof. In one more specific embodiment, the amount of such a blowing agent can be specifically from about 0.1 to about 50 weight percent, more specifically of from about 1 to about 40, most specifically of from about 5 to about 30 weight percent based on the combined weight of first and second resin.

In one specific embodiment herein, filler can be those such as the non-limiting examples of a porous polymer, silica, titanium dioxide, carbon black and combinations thereof. In one embodiment the other component can comprise a processing oil or wax that is compatible with the polymers used herein; which is especially useful in formulations that already contain oil and/or will benefit from the use of an oil as a processing aid, plasticizer, lower oil absorption formulation and/or softening agent. In one specific example some non-limiting examples of porous polymer are ACCUREL polyolefin (Akzo Nobel), STAMYPOR polyolefin (DSM) and VALTEC polyolefin (Montell), SPHERILENE polyolefin (Montell), and other fillers such as AEROSIL silica (Degussa), MICRO-CEL E (Manville) and ENSACO 350G carbon black (MMM Carbon). In another specific embodiment herein, a more specific processing oil is a white oil, such as the non-limiting example of paraffinic oils. In yet a further specific embodiment a non-limiting example of a processing wax is a paraffinic wax, but any oil and/or wax compatible with the above described first resin and optional second resin, if present, can be used.

In one embodiment herein, the above-described process can advantageously be performed as a continuous process and/or operated in a single step. In another specific embodiment, the above-described process can be a batch process. In yet another specific embodiment, any mixer suitable for the purpose described herein can be used, although more specifically mixer is a screw type mixer with at least two feed points, wherein mixer has a barrel and one of said feed points are located at an upstream position along the barrel of the mixer and a second feed point is located at a downstream position along the barrel. In another specific embodiment herein the mixer can be an extruder (single screw, twin screw, etc.), a BUSS KO-KNEADER mixer, a simple internal type mixer and combinations thereof. In one specific embodiment herein the conditions for mixing depends on the first resin and optional second resin and the degree of the herein described cross-linking.

In one specific embodiment, a resulting product of the above-described process is a hot melt vulcanizate composition, specifically a thermoplastic and/or elastomeric hot melt vulcanizate composition, more specifically a thermoplastic and/or elastomeric hot melt vulcanizate composition with excellent mechanical properties. In one specific embodiment hot melt vulcanizate composition which contains the above-described cross-linking of alkylamine possessing two or more amine functionalities (3) and carboxylic acid anhydride (2) has a much more significant gel content and a much lower melt flow index (MFI), (MFI ASTM D-1238 measured using a Tinius Olsen Extrusion Plastometer Model MP993a, 140° C., 2.16 Kg weight) than a vulcanizate composition that does not containing such cross-linking, which should improve the creep resistance, provide higher tensile strength at break and provide a vulcanizate composition that is harder than a vulcanizate compositions which does not have said cross-linking. In one embodiment herein, vulcanizate composition has a gel content of specifically about 10% greater, more specifically about 15% greater and most specifically about 20% greater than a vulcanizate composition that does not contain the above described cross-linking. In one other embodiment vulcanizate composition has a melt flow index that is specifically 95% less, more specifically 75% less and most specifically 50% less than a vulcanizate composition that does not contain the above described cross-linking. In one specific embodiment, the hot melt vulcanizate composition has elastic properties such as the non-limiting example of, elongation at break of greater than 400%, but can be melt processed with methods normally known in the art for thermoplastics. In one specific embodiment, the gel content of the hot melt vulcanizate composition (i.e., rubber content) is specifically from about 10 wt % to about 50 wt %, more specifically from about 25 wt % to about 35 wt %, and most specifically from about 25 wt % to about 30 wt %. In one specific embodiment, the melt flow index of the hot melt vulcanizate composition is specifically 50 to 0.5, more specifically 40 to 5 and most specifically 40 to 10. In one more specific embodiment, by utilizing the above-described process in an extruder, the tensile and flexible moduli in the extruder machine and transverse directions are improved, as is the dart impact strength of the hot melt vulcanizate composition.

In one specific embodiment, the hot melt vulcanizate composition herein is paintable and has better oil resistance. In another specific embodiment herein, the hot melt vulcanizate composition can be used in, the non-limiting examples of adhesives and/or sealants (such as the non-limiting example of a hot melt adhesive and/or sealant), cable insulations, pipes, profiles, moulded parts, foamed parts, sheets, and the like.

In one specific embodiment herein, reaction product (i) will tend to be more compatible with the optional second resin, providing for a stronger hot melt vulcanizate composition, such as a thermoplastic polymer containing vulcanizate composition (TPV) than a blended product of first resin (1) and optional second resin alone.

In one embodiment herein, hot melt vulcanizate composition is based upon a dispersed phase (reaction product (i)) which is a first blend comprising a carboxylic acid anhydride modified or peroxide grafted elastomeric polymer, further reacted with an alkylamine possessing two or more amine functionalities (3), and blended with a second blend of continuous phase thermoplastic polymer (second resin), and at least one additive such as the non-limiting examples of organic resin tackifiers, adhesions promoters, fillers and plasticizers. In a more specific embodiment, hot melt vulcanizate composition herein exhibits an extended range of mechanical properties as well as improved creep resistance as determined by decreased melt flow over vulcanizate compositions which do not contain alkylamine (3). In one embodiment, the hot melt vulcanizate compositions disclosed herein have the excellent MVT properties of butyl rubber based sealant/adhesives suited for insulated glass manufacture. In a more specific embodiment, the disclosed hot melt vulcanizate composition compared to a TPV that cure during insulated glass manufacture have reduced volatile materials thus reducing chemical fogging. In another specific embodiment herein the disclosed hot melt vulcanizate composition has reduced volatile materials compared to an equivalent hot melt vulcanizate composition (such as a conventional TPV) that does not contain amine (4) and/or other embodiments disclosed herein. In an even more specific embodiment herein, reduced volatile materials (such as the non-limiting example of reduced volatile organic compounds (VOC's)) can comprise a level of volatile materials that is less than the level of volatile materials from an equivalent TPV that does not contain cross-linking between alkylamine possessing two or more amine functionalities (3) and carboxylic acid anhydride (2) and/or does not contain any of the embodiments described herein. In an even more specific embodiment herein hot melt vulcanizate composition has a reduced level of volatile materials, such as VOC's, compared to an equivalent TPV that does not contain cross-linking between alkylamine possessing two or more amine functionalities (3) and carboxylic acid anhydride (2); wherein said reduced volatile materials, such as VOC's, can comprise a level of volatile materials, of specifically less than about 10 weight percent of total weight of hot melt vulcanizate composition, more specifically, less than about 5 weight percent of total weight of hot melt vulcanizate composition, and most specifically less than about 2 weight percent of total weight of hot melt vulcanizate composition.

In one embodiment herein, blend of reaction product (i) and optional second resin is a blend of: (a) an elastomeric polymer and/or copolymer (rubber phase), such as the non-limiting examples of the elastomeric polymers and/or copolymers described above (first resin); (b) a crystalline or partly crystalline thermoplastic polymer and/or copolymer, such as the non-limiting examples of thermoplastic polymers and/or copolymers described above (second resin); (c) a carboxylic acid anhydride, such as those described above, which is incorporated as a comonomer in, or grafted with a free radical generator catalyst (d), such as the non-limiting examples of the peroxides described above, or other suitable means, onto elastomeric polymer and/or copolymer (a); (e) an alkylamine possessing two or more amine functionalities, such as those described above; and (f) an organic resin tackifier and/or silane adhesion promoter, both of which are described above.

In accordance with one specific embodiment herein, based upon total weight of hot melt vulcanizate composition, hot melt vulcanizate composition, includes from about 5 wt % to about 40 wt % of second resin, specifically thermoplastic polymer, from about 60 wt % to about 95 wt % of first resin (1), specifically elastomeric polymer, from about 0.01 wt % to about 1.0 wt % of carboxylic anhydride (2), from about 0.005 wt % to about 0.5 wt % of (4), specifically, a peroxide, from about 0.25 wt % to about 2.5 wt % of alkylamine possessing two or more amine functionalities (3), and from about 5 wt % to about 25 wt % of tackifier; provided the total weight percent does not exceed 100%.

In accordance with one more specific embodiment herein, based upon total weight of hot melt vulcanizate composition, hot melt vulcanizate composition, includes from about 10 wt % to about 30 wt % of second resin, specifically thermoplastic polymer, from about 70 wt % to about 90 wt % of first resin (1), specifically elastomeric polymer, from about 0.05 wt % to about 0.5 wt % of carboxylic anhydride (2), from about 0.025 to about 0.25 wt % of (4), specifically, a peroxide, from about 0.5 wt % to about 2.0 wt % of alkylamine possessing two or more amine functionalities (3), and from about 10 wt % to about 25 wt % of the tackifier; provided the total weight percent does not exceed 100%.

In accordance with one most specific embodiment herein, based upon total weight of hot melt vulcanizate composition, hot melt vulcanizate composition, includes from about 15 wt % to about 25 wt % of second resin, specifically thermoplastic polymer, from about 75 wt % to about 85 wt % of first resin (1), specifically elastomeric polymer, from about 0.1 wt % to about 0.4 wt % of carboxylic anhydride (2), from about 0.05 to about 0.2 wt % of (4) specifically, a peroxide, from about 1.0 wt % to about 2.0 wt % of alkylamine possessing two or more amine functionalities (3), and from about 15 wt % to about 20 wt % of tackifier; provided the total weight percent does not exceed 100%.

In one specific embodiment of the process herein, in a first reaction, carboxylic acid anhydride (2) is grafted (most specifically by a free radical mechanism) onto first resin (1), specifically, elastomeric polymer and/or copolymer. In another specific embodiment, this reaction may be done with both first resin (1) and optional second resin present or with the first resin and second resin separated, though it is more specific to accomplish this with both first and second resins present. In a further embodiment, and as stated before, alternatively, this step can be effectively accomplished by the inclusion of carboxylic acid anhydride (2) as a comonomer in first resin (1), specifically elastomeric polymer (in which case, no free radical generator (4), i.e., peroxide is necessary). In another embodiment, first resin (1), specifically, elastomeric polymer should be grafted/copolymerized with carboxylic acid anhydride (2) prior to reaction with alkylamine possessing two or more amine functionalities (3), since the reaction product between acid anhydride (2) and alkylamine (3) has only a poor grafting efficiency. In another embodiment, a prior reaction between alkylamine possessing two or more amine functionalities (3) and acid anhydride (2) would result in the formation of a semiamide, which could have inferior grafting properties. In one embodiment, in such a case, no crosslinking would occur. In another embodiment and in contrast, partial degradation of first resin (1), specifically elastomeric polymer, and/or the plasticizing effect of the semiamide may lead to a rise in melt flow index (MFI).

In one specific embodiment, free radical generating catalyst (4) can be added to acid anhydride (2) during the grafting step to induce the grafting of the acid anhydride (2) onto first resin (1), specifically elastomeric polymer.

In a further specific embodiment, a first additive, specifically a condensation catalyst, such as the non-limiting examples of any form of organotin or organotitanate, such as the non-limiting examples of, for example, dibutyltin diacetate, dibutyltin dilaurate, dibutyltin oxide, dibutyltin dineodecanoate, tetratisopropyl titanate, tetra(2-ethylhexyl) titanate, tetrabutyl titanate; and tertiary amines. The amount of catalyst component that is used herein is not narrowly limited as long as there is a sufficient amount to accelerate the reaction. In one embodiment herein it will be understood that one skilled in the art will provide condensation catalyst in an amount determined on the individual parameters of the reaction at hand which can be adjusted by those skilled in the art as necessary to achieve the reactions described herein. In one embodiment herein condensation catalyst can be present in an amount of specifically from about 1 ppm to about 2%, more specifically of from about 10 ppm to about 1.5% and most specifically of from about 20 ppm to about 1% weight percent based on the total weight of vulcanizate composition. In one embodiment herein condensation catalyst can be used to expedite the crosslinking process, though the semi-amide can act as a sufficient catalyst. In one embodiment herein the processes described herein can be conducted at specifically from about 100 to about 250 degrees Celsius, more specifically from about 100 to about 200 degrees Celsius and most specifically of from about 120 to about 200 degrees Celsius. In one specific embodiment, one to ten minutes at an elevated temperature of from about 60° C. to about 200° C. should ensure such crosslinking as described above occurs.

In another specific embodiment herein, total amount of first, second and third additive is only about 0.4% of total weight of blend of reaction product (i) and second resin, about five times less than the amount needed for peroxide or vinyl silane cure, which benefits the overall process in two ways: a reduction in total cost and a reduction of fugitive peroxides, which can present safety issues. In one specific embodiment herein the amount of fugitive peroxides present in the hot melt vulcanizate composition is less than an equivalent hot melt vulcanizate composition that does not contain an amine (3) and/or other embodiments described herein; specifically the amount of fugitive peroxides is about 75% less, more specifically 50% less and most specifically 25% less than an equivalent hot melt vulcanizate composition that does not contain an amine (3) and/or other embodiments described herein. In one embodiment at least one of first, second and third additive herein can be present in an amount of specifically from about 0.001 wt % to about 50 wt %, more specifically of from about 5 wt % to about 50 wt % and most specifically of from about 10 wt % to about 40 wt % weight percent based on the total weight of vulcanizate composition.

In one specific embodiment of process herein, and in contrast to prior methods of making TPV, the above-described process can be performed in a single operation. In another specific embodiment, in the above-described continuous process, grafting, cross-linking and coupling are performed continuously in blending apparatus. In another specific embodiment herein, above-described process is also suitable for use in a batch compounding system, such as the non-limiting examples of a Banbury or Krupp mixer, if desired. In one specific embodiment herein blending can comprise contacting together said reaction product (i) and second resin. In a more specific embodiment blending can be done in continuous process, specifically in an extruder.

In one specific embodiment herein, curing can comprise treating the blended reaction product (i) and second resin with a curing agent such as the same or different of the free radical generating catalyst disclosed above; and/or exposing the blended reaction product (i) and second resin to heat and/or air cooling and/or other conventional cooling techniques, for a period of time.

In one specific embodiment herein, it is possible to have first and second resins be the same or different wherein the acid anhydride (2) is pre-added with a peroxide (4) or in another specific example according to the above-described process of grafting acid anhydride (2) to one part of elastomeric polymer first resin (1), which pre-reacted elastomeric polymer first resin (1) will act as the rubber phase within the TPV. In one specific embodiment, such pre-addition includes the possibilities of having the acid anhydride (2) present as a comonomer in elastomeric polymer first resin (1) or pre-reacting the acid anhydride (2) with elastomeric polymer first resin (1). In another more specific embodiment, in either of these two cases, addition of separate acid anhydride (2) would not be necessary since it is present in elastomeric polymer first resin (1). In one specific embodiment herein, the above-described process can be accomplished in a single continuous mixer, several mixers in tandem, a batch mixer or any other suitable mixer typically used for the processing of elastomers and/or thermoplastic polymers.

In yet another embodiment first and second resins can be the same or different, but when the same, the acid anhydride (2) is added to the first resin (1) as a whole. In a more specific embodiment, in such a case, when the alkylamine possessing two or more amine functionalities (3) is added, part of first resin (1) would form reaction product (i), while another part would not react (given the relatively small amount of anhydride and alkylamine present). In one specific embodiment herein, it is important that a proper degree of phase separation between reaction product (i) and second resin is created during the process. In one embodiment herein, melt flow of the resins and/or reaction product (i) in the processes described herein, can be specifically of from about 0.5 to about 20, more specifically of from about 1 to about 15 and most specifically of from about 5 to about 15. In a more specific embodiment, this process can be accomplished in a single continuous mixer, several mixers in tandem, a batch mixer or any other suitable mixer typically used for the processing of elastomers and/or thermoplastic polymers.

In one specific embodiment herein, in the case of using two different first resin polymers such as both an elastomeric and thermoplastic polymer, the polymer that is more reactive with the acid anhydride will be grafted by the acid anhydride and will act as elastomeric polymer (first resin (1)) in the TPV. In another specific embodiment the above-described processes can have selective addition of any of the first, second and third additives to the process.

In one specific embodiment, the use of both alkylamine crosslinking agent (3) and tackifier in blend of reaction product (i) and second resin herein provides a hot melt vulcanizate composition having a three dimensional polymer structure which is advantageously used for adhesion and sealing, such as for the non-limiting example of a glazing compound for glass. In another specific embodiment, the blend is initially tacky until cured by, for example, reaction with a second free radical generating catalyst wherein second free radical generating catalyst can be the same or different as the free radical generating catalyst described above and wherein second free radical generating catalyst is such as those disclosed above, upon which the blend loses its tackiness until the hot melt vulcanizate composition is reheated, for example, when employed as a hot melt adhesive or in a hot melt adhesive composition. In another embodiment herein, the hot melt vulcanizate composition regains its tackiness when melted for application to a surface to be bonded (e.g., glass) and then becomes non-tacky when cooled. In another embodiment, without curing and specifically without curing using second free radical generating catalysts, the compound may remain permanently tacky, which would make it unsuitable for use in many applications such as, e.g., window glazing compounds.

In one specific embodiment herein, there is provided a composite structure comprising: at least one transparent or translucent panel member having at least two surfaces to said panel member wherein at least one of said surfaces has an adhesive and/or sealant comprising a hot melt vulcanizate composition disposed on at least a portion thereof; wherein said hot melt vulcanizate composition is made by the process comprising:

a) producing a reaction product (i) from (1) at least one first resin selected from the group consisting of thermoplastic polymer and elastomeric polymer, (2) at least one unsaturated carboxylic acid anhydride, (3) at least one alkylamine possessing two or more amine functionalities, and optionally (4) at least one free-radical generating catalyst, and wherein said reaction product (i) optionally further comprises, at least one first additive; and, optionally,

b) blending said reaction product (i) with at least one second resin selected from the group consisting of thermoplastic polymer and elastomeric polymer, provided that at least one of second resin is different from at least one of first resin and, optionally, at least one second additive;
c) curing said reaction product (i), wherein reaction product (i) has been blended as in (b) above, or not, to produce a hot melt vulcanizate composition; and, optionally,

d) adding at least one third additive to the hot melt vulcanizate composition; wherein a composite structure is comprised of said panel member.

In a further specific embodiment herein the panel members are glass or plastic sheets for use in windows. In another specific embodiment they can also be called glazing sheets. In one embodiment herein, glass members include simple glass, coated glass sheets, tempered glass, and low emissivity (E) glass, which has been treated on one or more surfaces with various metal oxides. In another specific embodiment, some typical non-limiting coatings for E glass include layers of iridium oxide and/or elemental silver and optionally layers of zinc oxide and/or titanium oxide. In one embodiment, generally, glass thicknesses vary from about 0.080 to about 0.25 inches (about 0.20 to about 0.64 cm), although the glass can be thinner or thicker for specific applications. In another embodiment, polymer (plastic) sheets due to their higher moisture vapor transmission rates and lower weight are preferably intermediate layers in insulated windows with three or more members. In a more specific embodiment, these multiple panel windows can have seals between all panel members or can have panels positioned between two other panel members, which are joined by a single seal. In yet an even more specific embodiment, panels can have mirrored, reflective, or tinted layers on one or more surfaces or an internal tint; wherein any of these layers or tints can comprise a plastic member such as a sheet, containing an adhesive, specifically a transparent adhesive thereon.

In one specific embodiment there is provided an insulated glass and/or plastic window unit comprising said composite structure.

In yet another embodiment herein, the primary function of adhesive and/or sealant comprising hot melt adhesive composition is adhering and the secondary function is acting as a moisture vapor barrier at the interface between a spacer and the transparent or translucent panels.

In one embodiment herein there is provided a composite structure comprising at least two panel members wherein the panel members are placed generally parallel to each other and contain a finite space between said panel members and contain a seal on the peripherary of said panel members and/or on at least one of the surfaces of the panel members wherein said seal comprises hot melt vulcanizate composition. In a further specific embodiment herein, said seal can comprise at least one longitudinal core material, at least one longitudinal adhesive film (such as films comprising hot melt vulcanizate composition described herein) in physical contact with said core material and which adheres said core material to said panel members and at least one longitudinal spacer element substantially perpendicular to said panel members. In a further embodiment herein, any one or more of said seal, panel members and adhesive film can be any of those described in U.S. Pat. Nos. 5,851,609 and 6,355,328 the contents of which are incorporated by reference herein in their entirety.

In a further embodiment said composite structure can comprise a vacuum or a gas in the space between said panel members, which are sealed by said seal. In a more specific embodiment, such a gas can comprise, air, argon, sulfur hexafluoride, or combinations thereof.

In yet a further specific embodiment said composite structure can comprise general glass and/or window structures such as the non-limiting examples of a window, window glazing, an insulated thermal (i.e., window) unit and combinations thereof. In a more specific embodiment window glazing can comprise automotive window glazing, wherein more specifically said automotive window glazing can have a thermal barrier and/or decorative facing, wherein said thermal barrier can be provided by said composite structure. In another specific embodiment insulated thermal unit can be an insulated unit for residential, commercial and industrial construction, such as an insulated window unit. In one specific embodiment an insulated thermal unit can be assembled at the location of installation and/or in manufacture of said insulated thermal unit. In a more specific embodiment, a manufacturer of insulated thermal unit can do any one of not assemble the thermal unit, partially assemble the thermal unit or fully assemble the thermal unit prior to shipping said thermal unit to location of installation. In one embodiment an unassembled thermal unit and/or partially assembled thermal unit can be modified to specific requirements and/or desirabilities when received at location of installation.

In another embodiment herein the composite structure as described above, can be a composite structure wherein adhesive and/or sealant is a hot melt adhesive and/or sealant. In yet another embodiment the composite structure can have a reduced level of volatile materials; wherein a reduced level of volatile materials is as described above. In yet another embodiment herein the composite structure can have an amount of fugitive peroxides present in the composite structure that is less than an equivalent composite structure having a an equivalent hot melt vulcanizate composition that does not contain an amine (4) and/or other embodiments described herein. In yet another embodiment herein the amount of fugitive peroxides present in the composite structure can be the same amount of fugitive peroxides present in hot melt vulcanizate composition described above.

The invention can be better understood by reference to the following examples in which the parts and percentages are by weight unless otherwise indicated.

### EXAMPLES

Two examples and a comparative example are presented below. The comparative example does not illustrate the disclosed embodiments.

The following components are employed in the examples: isobutylene-isoprene copolymers (butyl rubber) available from ExxonMobil under the designation Butyl 268 and Butyl 165, hydrocarbon tackifier resin available from ExxonMobil Chemical under the designation Escorez 1304, high molecular weight polyisobutylene available under the designations Vistanex L-100 and L-140, maleic anhydride modified styrene ethylene-butylene styrene block copolymer available from Kraton polymers under the designations Kraton FG 1901 and Kraton FG 1924×, liquid synthetic depolymerized butyl rubber available from Hardman Co. under the designation Kalene 800, terpene-phenolic tackifier available from Arizona chemical Co. under the designation Sylvarez TR1085, ethylene-vinyl acetate resin available from DuPont under the designation Elvax® 460, partially hydrogenated cycloaliphatic petroleum hydrocarbon resin tackifier available from Eastman Chemical Co. under the designation Eastotac H-100W, and calcium carbonate available from Pfizer under the designations Ultra-pflex and Hi-pflex.

### Comparison Examples 1 and 2, and Examples 1 and 2

The composition for comparative example in Table 1 were prepared using a Braybender at 160° C., 150 rpm with reaction of an aminosilane and further reaction at 200° C. to release moisture that resulted in Si—O—Si crosslinking. Examples 1 and 2 were prepared as for the comparison example except without further heating at 200° C. since release of moisture is not required for crosslinking. Samples were cooled to room temperature then milled on an EEMCO two roll mill without heat using a 0.25 inch gap setting. Samples were then hot press molded to 0.125 inch by 4 inch by 4 inch slabs for physical property testing.

Examples 1 and 2 demonstrate that a non-silane alkylamine possessing two or more amine functionalities crosslinker is effective in crosslinking the dispersed phase increasing creep resistance as shown by the melt flow rate.

TABLE 1

| | Formulations (%) | | | |
|---|---|---|---|---|
| | Comparison | Comparison | | |
| Ingredients | Example 1 | Example 2 | Example 1 | Example 2 |
| Butyl 268 | 14.9 | 14.9 | 15.0 | 14.9 |
| Kraton FG 1924X | 18.6 | 19.9 | 18.7 | 18.6 |
| Kalene 800 | 11.2 | 19.9 | 11.3 | 11.2 |
| Escorez 1304 | 11.1 | 49.7 | 11.2 | 11.2 |
| Sylvarez TR1085 | 11.1 | | 11.2 | 11.2 |
| Eastotac H-100W | 11.1 | 24.8 | 11.2 | 11.2 |
| Elvax 460 | 8.5 | 14.2 | 8.5 | 8.5 |
| Aluminum trihydrate | 4.3 | | | |
| Talc | | 7.1 | 4.3 | 4.3 |
| Ultra-pflex | 4.3 | 7.1 | 4.3 | 4.3 |
| Hi-pflex | 4.3 | 7.1 | 4.3 | 4.3 |
| A-1100/20 ppm Dibutyltin dilaurate | 0.65 | | | |
| 1,7-diaminoheptane | | | 0.18 | 0.55 |
| Melt Flow¹, g/10 min. | <1 | 9.8 | <1 | <1 |
| Tensile² psi | 230 | 460 | 174 | 257 |
| 100% Modulus² psi | 64 | 132 | 70 | 72 |
| Elongation², % | 756 | 449 | 488 | 758 |
| Tear B³, lbs/in | 77 | 80 | 59 | 76 |
| Shore A⁴ | 18 | 9.8 | 2 | 22 |

¹Melt Flow per ASTM 1238 measured using a Tinius Olsen Extrusion Plastometer Model MP993a, 140° C., 2.16 Kg weight.
²ASTM D412-86
³ASTM D624-80
⁴ASTM D2240-86

While the above description contains many specifics, these specifics should not be construed as limitations of the disclosure, but merely as exemplifications of preferred embodiments thereof. Those skilled in the art will envision many other embodiments within the scope and spirit of the disclosure as defined by the claims appended hereto.

What is claimed is:

1. A hot melt vulcanizate composition made by the process comprising:
a) producing a reaction product (i) from (1) at least one first resin selected from the group consisting of thermoplastic polymer and elastomeric polymer, (2) at least one unsaturated carboxylic acid anhydride, (3) at least one alkylamine possessing two or more amine functionalities, and optionally (4) at least one free-radical generating catalyst, and wherein said reaction product (i) optionally further comprises, at least one first additive; and, optionally,
b) blending said reaction product (i) with at least one second resin selected from the group consisting of thermoplastic polymer and elastomeric polymer, provided that at least one of second resin is different from at least one of first resin and, optionally, at least one second additive;
c) curing said reaction product (i), wherein reaction product (i) has been blended as in (b) above, or not, to produce a hot melt vulcanizate composition; and, optionally,
d) adding at least one third additive to the hot melt vulcanizate composition.

2. The hot melt vulcanizate composition of claim 1 wherein the thermoplastic polymer of first and second resin is selected from the group consisting of homopolymers and copolymers of polypropylene, polyethylene, polystyrene, acrylonitrile butadiene styrene, styrene acrylonitrile, polymethylmethacrylate, polyester, polycarbonate, polyamide, polyphenylene ether, polyphenylene oxide and combinations thereof.

3. The hot melt vulcanizate composition of claim 1 wherein the elastomeric polymer of first and second resin is selected from the group consisting of of ethylene propylene copolymer, ethylene propylene diene terpolymer, butyl rubber, natural rubber, chlorinated polyethylene, silicone rubber, isoprene rubber, butadiene rubber, styrene-butadiene rubber, SEBS, ethylene-vinyl acetate, ethylene butylacrylate, ethylene methacrylate, ethylene ethylacrylate, ethylene-alpha-olefin copolymers, high density polyethylene, nitrile rubber and combinations thereof.

4. The hot melt vulcanizate composition of claim 1 wherein the unsaturated carboxylic acid anhydride (2) is selected from the group consisting of isobutenylsuccinic, (+/−)-2-octen-1-ylsuccinic, itaconic, 2-dodecen-1-ylsuccinic, cis-1,2,3,6-tetrahydrophthalic, cis-5-norbornene-endo-2,3-dicarboxylic, endo-bicyclo[2.2.2]oct-5-ene-2,3-dicarboxylic, methyl-5-norbornene-2,3-carboxylic, exo-3,6-epoxy-1,2,3,6-tetrahydrophthalic, maleic, citraconic, 2,3 dimethylmaleic, 1-cyclopentene-1,2-dicarboxylic, 3,4,5,6-tetrahydrophthalic; and combinations thereof.

5. The hot melt vulcanizate composition of claim 1 wherein the alkylamine possessing two or more amine functionalities (3) has the general formula (I):
R¹₂N—R—NR²₂ (I)
wherein R is a linear, branched or cyclic divalent alkylene group containing from 1 to about 20 carbon atoms, said divalent alkylene group optionally containing at least one interposed amine group; each R¹ and R² is independently hydrogen, or the same or different linear or branched alkyl group of from 1 to about 8 carbon atoms.

6. The hot melt vulcanizate composition of claim 5 wherein the alkylene group contains from 2 to about 12 carbon atoms.

7. The hot melt vulcanizate composition of claim 5 wherein the alkylene group contains from 2 to about 8 carbon atoms.

8. The hot melt vulcanizate composition of claim 1 wherein the alkylamine (3) comprises at least one of a polyoxypropylene diamine and a polyoxypropylene dialkyldiamine.

9. The hot melt vulcanizate composition of claim 1 wherein the alkylamine (3) is selected from the group consisting of 5-amino-1,3,3-trimethylcyclohexanemethylamine, 1,4-diaminocyclohexane, 1,3-propanediamine, 1,3-pentanediamine, isophoronediamine, diethylenetriamine, triethylenetetramine, trimethylhexamethylenediamine, N,N′-dimethylethylenediamine, N,N′-diethyl-1,3-propanediamine, bis(aminomethyl)cyclohexylamine, bis(p-aminocyclohexyl)methane, 2,2′-dimethylbis(p-aminocyclohexyl)methane, 1,2-diaminocyclohexane, metaxylenediamine, norbornanediamine, diethyltoluenediamine, 1,7-diaminoheptane; polyoxypropylene diethyldiamine, N,N′-diethyl-isophoronediamine; and combinations thereof.

10. The hot melt vulcanizate composition of claim 1 wherein free radical generating catalyst (4) is selected from the group consisting of water soluble peroxides, oil soluble peroxides and combinations thereof.

11. The hot melt vulcanizate composition of claim 1 wherein the first, second, and/or third additive is selected from the group consisting of tackifier, plasticizer, silane adhesion promoter, condensation catalyst, other component and combinations thereof.

12. The hot melt vulcanizate composition of claim 11 wherein tackifier is selected from the group consisting of partially or fully hydrogenated cycloaliphatic petroleum hydrocarbon resins, partially or fully hydrogenated aromatic modified petroleum hydrocarbon resins; aliphatic-aromatic petroleum hydrocarbon resins; styrenated terpene resins made from d-limonene and alpha-methylstyrene resins; and combinations thereof.

13. The hot melt vulcanizate composition of claim 11 wherein silane adhesion promoter is of the general formula:
(YₐZB)_{c}Si(OR)_{b}(X)_{4-(b+c)},
wherein a=0 to 2, b=1 to 3, c=1 to 3, with the proviso that b+c is less than or equal to 4, each Y may independently be selected from hydrogen, an alkyl, alkenyl, hydroxy alkyl, alkaryl, alkylsilyl, alkylamine, C(═O)OR or C(═O)NR, C(═O)R, alkylepoxy, Z is N or S or B, R is an acyl, alkyl, aryl or alkaryl, X is R or a halogen wherein R is a monovalent alkyl, B is a divalent straight chain, branched chain, cyclic hydrocarbon, aryl, alkylaryl or combination thereof bridging group, or B may contain at least one heteroatom bridge.

14. The hot melt vulcanizate composition of claim 11 wherein other component is selected from the group consisting of UV stabilizers, antioxidants, metal deactivators, processing aids, waxes, fillers, colorants, blowing agents and combinations thereof.

15. The hot melt vulcanizate composition of claim 1 wherein blending is conducted as a continuous process.

16. The hot melt vulcanizate composition of claim 1 wherein blending is conducted in a screw type mixer-extruder.

17. A hot melt adhesive and/or sealant comprising the hot melt vulcanizate composition of claim 1.

18. The hot melt adhesive and/or sealant of claim 17 having a reduced level of volatile materials.

19. The hot melt adhesive and/or sealant of claim 17 having a level of volatile materials of less than about 10% by weight of the weight of the vulcanizate composition.

20. The hot melt adhesive and/or sealant of claim 17 having an amount of fugitive peroxides present in the hot melt vulcanizate composition that is less than an equivalent hot melt vulcanizate composition that does not contain an amine (4).

21. The hot melt adhesive and/or sealant of claim 17 having a level of fugitive peroxides present in the hot melt vulcanizate composition of 25% less than an equivalent hot melt vulcanizate composition that does not contain an amine.
